(19) United States
(12) Patent Application Publication
(10) Pub. No.: US 2026/0201860 A1
(43) Pub. Date: Jul. 16, 2026

(54) REPOWERED WIND TURBINE

(71) Applicant: VESTAS WIND SYSTEMS A/S, Aarhus N (DK)

(72) Inventors: Mohammed FAJAR, Hinnerup (DK); Jens Bredal NIELSEN, Struer (DK); Thomas S. Bjertrup NIELSEN, Skødstrup (DK)

(21) Appl. No.: 19/131,703

(22) PCT Filed: Dec. 11, 2023
(86) PCT No.: PCT/DK2023/050299

§ 371 Date: May 21, 2025

(30) Foreign Application Priority Data
Dec. 9, 2022 (DK) PA202270592

(51) Int. Cl. F03D 1/06

(52) U.S. Cl. CPC F03D 1/0642; F05B 2240/307

(57) ABSTRACT

According to the present invention there is provided a repowered wind turbine comprising a rotor rotatably mounted to a nacelle The rotor defines a rotor axis. The rotor comprises a plurality of repowered wind turbine blades connected to a hub. Each repowered blade extends in a radial direction from a blade root to a blade tip and in a chordwise direction between a leading edge and a trailing edge, and each repowered blade comprises a blade shell. At least a portion of each blade shell is formed of at least a portion of a used blade shell of a used wind turbine blade. The repowered wind turbine further comprises a connecting fixture attached to each repowered blade. Each connecting fixture defines a connection point for connecting a blade connecting member to the repowered blade. The repowered wind turbine further comprises one or more blade connecting members. Each blade connecting member is connected between corresponding connection points of a pair of repowered wind turbine blades such that each repowered blade is connected to at least one other repowered blade by a blade connecting member.

### TECHNICAL FIELD

The present invention relates generally to wind turbines and more particularly to a repowered wind turbine comprising repowered blades that each have a blade shell comprising a portion of a used blade shell of a used wind turbine blade.

### BACKGROUND

Wind turbines have been installed in on-shore and off-shore locations for many years to generate renewable energy from the wind. As well as many smaller components, wind turbines typically include a tower, a nacelle mounted on the tower and a rotor mounted to the nacelle. The nacelle houses a drivetrain and power-generating components for converting kinetic energy into electrical energy. Each of these components of a wind turbine are designed and installed based on factors such as predicted wind conditions, predicted loading in use, and the best available technology at the time of installation.

Advances in wind turbine technology mean that new installations may be capable of capturing more energy from the wind than existing, earlier installations. However, the installation of a wind turbine, including building foundations and erecting the tower, is an expensive and time-consuming operation. In some examples it may therefore be advantageous to repower an existing wind turbine by applying new technology to the turbine to capture more energy from the wind and increase the annual energy production (AEP) of the existing turbine.

For example, new power-generating components may be exchanged for existing power-generating components to produce more power from the rotation of the rotor. However, uncoupling and exchanging power-generating components up-tower may be complicated or impossible, and such operations may result in significant down-time where the turbine is not generating power. In theory, increasing the diameter of the rotor increases the amount of energy captured from the wind. However, it is often not possible to increase the rotor diameter, or the increase is very limited, because longer blades experience higher blade loads, and/or because a larger rotor is typically heavier, resulting in increased loading of components in the hub, nacelle and/or tower. Further, exchanging large components, such as wind turbine blades, may require substantial quantities of raw materials and may therefore be both financially and environmentally disadvantageous.

It is against this background that the present invention has been devised.

### SUMMARY

According to the present invention there is provided a repowered wind turbine comprising a rotor rotatably mounted to a nacelle. The rotor defines a rotor axis. The rotor comprises a plurality of repowered wind turbine blades connected to a hub. Each repowered blade extends in a radial direction from a blade root to a blade tip and in a chordwise direction between a leading edge and a trailing edge, and each repowered blade comprises a blade shell. At least a portion of each blade shell is formed of at least a portion of a used blade shell of a used wind turbine blade. The repowered wind turbine further comprises a connecting fixture attached to each repowered blade. Each connecting fixture defines a connection point for connecting a blade connecting member to the repowered blade. The repowered wind turbine further comprises one or more blade connecting members. Each blade connecting member is connected between corresponding connection points of a pair of repowered wind turbine blades such that each repowered blade is connected to at least one other repowered blade by a blade connecting member.

In the present context the term ‘blade connecting member’ should be interpreted broadly to include examples such as flexible connecting members and rigid connecting members. As such, in some examples the blade connecting member may comprise a cable. Preferably the blade connecting member may therefore be a blade connecting cable, and the repowered wind turbine may therefore comprise a cable-stayed rotor. For example, in the present context, a ‘cable’ may be a braided or laid rope of metal wires (such as steel wires, for example), polymer fibres (such as polyethylene, polypropylene, nylon, polyester, aramid fibres, for example), inorganic fibres (such as carbon fibres, for example) or hybrid ropes of such materials. In some other examples, a blade connecting member may comprise a composite member such as a pultrusion, or alternatively a blade connecting member may comprise a rod such as a metal or polymer rod, to name a few possible examples.

In use, each blade connecting member connected between corresponding connection points of a pair of repowered wind turbine blades advantageously reduces the loads experienced by a portion of the respective repowered blade inboard of the connection point. This is because some of the blade loads are diverted to the blade connecting member instead of progressing to the hub via the inboard portion of the repowered blade. In particular, loads may be transferred from a higher loaded blade to a lesser loaded blade via a blade connecting member in use. The blade connecting members therefore cause the repowered wind turbine blades to mutually support each other, in the sense that loads on the repowered wind turbine blades, in particular edgewise loads and flapwise loads, are ‘shared’ among the repowered wind turbine blades, via the blade connecting members. The use of blade connecting members is particularly advantageous for reducing edgewise fatigue loads, i.e. gravity driven loads.

In some examples, the repowered wind turbine may comprise a plurality of connecting members connected to one another in series between corresponding connection points of a pair of repowered blades. Such a configuration may be advantageous for assembly and maintenance of the repowered wind turbine.

It will be appreciated that each connecting fixture is preferably configured as a structure for transferring loads from the repowered blade, i.e. from the blade shell, to a blade connecting member via the respective connection point.

In some examples, each repowered blade may comprise a used wind turbine blade and a retrofitted tip extension attached to the used wind turbine blade. For example, the tip extension may comprise a sleeve portion shaped to fit over a tip end of the used wind turbine blade. Each repowered blade may therefore comprise substantially an entire used blade shell of a used wind turbine blade. Alternatively, in some other examples, a portion of the used blade shell of the used wind turbine blade may be removed before attaching the tip extension to the used wind turbine blade.

In some examples, the tip extension may be attached to the used wind turbine blade using adhesive. Additionally or alternatively, the tip extension may be attached to the used wind turbine blade by a mechanical connection such as a bolted connection, in some examples.

In some examples, the tip extension may have a radial length of at least 4 m, preferably at least 5 m, more preferably at least 6 m. As such, the tip extension may significantly increase the potential amount of wind energy that can be captured by the repowered wind turbine blade of the repowered wind turbine compared to the used wind turbine blade.

In some examples, each repowered blade may comprise a used wind turbine blade and a retrofitted root extension attached to a blade root of the used wind turbine blade. Accordingly, in some examples the repowered wind turbine may comprise a plurality of used wind turbine blades each connected to the hub via a respective retrofitted root extension part. In some examples, the retrofitted root extension part may be attached to the blade root of the used wind turbine blade by a bolted connection. In some examples the retrofitted root extension part may be connected to the hub by a bolted connection.

In some examples, at least part of an inboard section of the blade shell of each repowered blade may be formed of at least part of an inboard portion of a used blade shell. Additionally or alternatively, at least part of an outboard section of the blade shell of each repowered blade may be formed of at least part of an outboard portion of a used blade shell, in some examples. In some examples, substantially the entire inboard section of each repowered blade shell may be formed of at least part of an inboard portion of a used blade shell. Additionally or alternatively, substantially the entire outboard section of each repowered blade shell may be formed of at least part of an outboard portion of a used blade shell, in some examples. In some examples, the repowered blades of the repowered wind turbine may each comprise shell portions of different used wind turbine blades.

In some examples, each connecting fixture may be attached to both the inboard section and the outboard section of each respective blade shell. Accordingly, each connecting fixture may span a joint region at which the inboard and outboard sections of the blade shell are connected to one another. It follows that in some examples, the inboard section of each blade shell may be connected to the outboard section of the respective blade shell by the connecting fixture.

In some examples, the inboard section of each repowered blade may comprise at least 25%, preferably at least 40%, more preferably at least 55% of the total length of the repowered blade. In some examples, the inboard section of each repowered blade may comprise at most 65%, preferably at most 60% of the total length of the repowered blade.

In some examples, each connecting fixture may be retrofitted to an outer surface of the blade shell of each respective repowered blade.

In some examples, each repowered wind turbine blade of the repowered wind turbine may be connected to the hub via a hub extender. Typically, repowered blades are connected to a hub at a blade-to-hub interface. Providing a hub extender between the hub and the blade root, i.e. connecting each repowered blade to the hub via a hub extender, may therefore provide the blade-to-hub interface further outboard than the typical example noted above. This may increase the diameter of the rotor of the repowered wind turbine.

In some examples, each connecting fixture may extend over a radial extent of between 0.5C and 1.5C, where C represents the chord length between the leading edge and the trailing edge of the repowered blade at the connection point. Alternatively, in some examples the connecting fixture may extend over a radial extent of between 0.01R and 0.05R, where R represents half of the repowered rotor diameter. It will be appreciated that R may be referred to as the repowered rotor radius. For example, the connecting fixture may extend over a radial extent of at least 2 m, and preferably over at least 3 m. Most preferably, the connecting fixture may extend over a radial extent of between 4 m and 6 m.

A connecting fixture that extends over a radial extent of between 0.5C and 1.5C may provide an advantageous area for transferring loads from the blade shell to the blade connecting member in use (via the connection point). Additionally, a radial extent of between 0.5C and 1.5C may help to facilitate the formation of a smooth outer surface of the connecting fixture to transition smoothly from an outer profile of the blade shell to reduce the drag caused by the connecting fixture.

In some examples, each connecting fixture may be attached to a respective repowered blade such that the connection point is located at a radial distance of between 0.25R to 0.55R from the rotor axis, where R represents half of the rotor diameter. For example, the connecting fixture may be attached to the repowered blade such that the connection point is located at a radial distance of 20 to 40 m such as about 25 m from the rotor axis, in some examples.

Loads experienced by the root and a portion of the repowered blade inboard of the connection point decrease with an increase in the radial distance at which the connection point is located from the rotor axis. This is because the blade connecting member can take up, i.e. divert, a greater proportion of the loads experienced by the repowered blade if it is located further outboard. However, noise and the negative effect of drag caused by the connecting fixture both increase with an increase in the radial distance at which the fixture is attached. A connecting fixture attached to the repowered blade such that the connection point is located at a radial distance of between 0.25R to 0.55R from the rotor axis provides an advantageous compromise between the advantages and drawbacks of attaching a connecting fixture to the repowered blade.

In some preferred examples, each connecting fixture may be bonded to each respective repowered blade using adhesive. For example, the connecting fixture may be bonded to the blade shell of the respective repowered blade. An adhesive joint between the connecting fixture and blade shell may be advantageous for load distribution and load transfer between the connecting fixture and blade shell because loads may be transferred over a large area.

In examples where the repowered wind turbine blades of the repowered wind turbine comprise an inboard and/or outboard blade shell section as described previously, the connecting fixture may be bonded to both the inboard section and the outboard section of the blade shell using adhesive.

In some examples, each connecting fixture may additionally or alternatively be attached to each respective repowered blade by a plurality of fixing members that extend into the blade shell. In some examples, the fixing members may comprise bolts. In some examples the fixing members may comprise tapered spears. The fixing members may extend into the blade shell in a direction orthogonal to the shell surface or generally parallel to the shell surface. The fixing members may extend into and through the shell into an interior cavity of the repowered blade in some examples. Alternatively, in some examples the fixing members may extend into, but not through, the blade shell.

In examples where the repowered wind turbine blades of the repowered wind turbine comprise an inboard and/or outboard blade shell section as described previously, the connecting fixture may be attached to the inboard section of the blade shell using one or more fixing members that extend into the inboard section of the blade shell, and the connecting fixture may be attached to the outboard section of the blade shell using one or more fixing members that extend into the outboard section of the blade shell.

In some examples, each repowered wind turbine blade may comprise one or more layers of reinforcing material laminated over an inboard edge of the connecting fixture attached to the repowered blade. Additionally or alternatively, each repowered wind turbine blade may comprise one or more layers of reinforcing material laminated over an outboard edge of the connecting fixture attached to the repowered blade. Overlaminating one or more edges of the connecting fixture may advantageously increase the strength of the joint attaching the connection fixture to the repowered blade. Further, the or each layer of reinforcing material laminated over an edge of the connecting fixture may help to provide a smooth transition between the blade shell and the connecting fixture. Accordingly, overlaminating the inboard and/or outboard edge of the connecting fixture may help to reduce the aerodynamic drag caused by the connecting fixture.

In some preferred examples the repowered wind turbine blades may be pitchable, i.e. rotatable about their respective longitudinal axis, relative to the hub. For example, the repowered wind turbine blades may each be connected to the hub via a respective pitch mechanism. As such, the rotor may be referred to as a pitchable rotor. The repowered wind turbine may therefore comprise a cable-stayed pitchable rotor in some examples.

In some examples, each repowered blade may be connected to the hub via one or more shim angle adjustment members. The shim angle adjustment members may set an in-plane inclination and/or an out-of-plane inclination of each repowered blade. The in-plane inclination may be measured between a theoretical centreline of the repowered blade and a pitch axis of the repowered blade in a plane parallel to the rotor plane. The out-of-plane inclination of each repowered blade may be measured between the theoretical centreline of the repowered blade and the pitch axis in a plane perpendicular to the rotor plane. As used herein, the theoretical centre line of the repowered blade connects a centre point of the blade root and a blade centre at the radial location of the connection point. The blade centre is defined as the intersection of the chord between the leading and trailing edges and a thickness line orthogonal to the chord at the maximum thickness, at the given radial location.

In some examples, each connecting fixture may comprise an inner profile shaped to substantially match an outer profile of the blade shell to which the connecting fixture is attached. This may help to ensure that forces and loads are distributed evenly across the joint between the connecting fixture and the blade shell, avoiding stress concentrations. Further, in some examples this may advantageously result in a consistent bondline thickness in the joint between the connecting fixture and the blade shell, which is also advantageous for transferring loads.

In some examples, each connecting fixture may extend around a leading edge of the repowered blade to which the fixture is attached. This may facilitate the provision of the connection point in an advantageous location on the airfoil profile, such as in a leading edge region. Further, extending around the leading edge of the repowered blade may mean that the aerodynamic impact of the connecting fixture is reduced.

In some examples, each connecting fixture may comprise a connecting collar that extends around and encloses a portion of the blade shell where the connecting fixture is attached. For example, when viewed in cross section the connecting fixture may form a closed perimeter entirely surrounding the outer profile of the portion of the blade shell to which the connecting fixture is attached. Such a configuration may advantageously provide a large joint area over which to distribute and transfer loads between the connecting fixture and blade shell. Further, such a configuration may provide a particularly robust and long-lasting attachment to the respective repowered blade.

In some examples, the connecting fixture may be formed of a plurality of parts. In preferred examples, any joints between separate parts of the connecting fixture may be overlaminated with one or more layers of reinforcing material. This may increase the strength of the joint between such separate parts of the connecting fixture, and may additionally form a smooth outer surface on the connecting fixture.

In some examples, the connecting fixture may comprise a plurality of parts which, when attached to the repowered blade form a connecting collar that extends around and encloses the portion of the blade shell where the connecting fixture is attached. For example, the fixture may comprise a windward part and a leeward part configured respectively for attachment to a windward side and a leeward side of the blade shell. The windward and leeward parts of the connecting fixture may meet at respective joints at the leading edge and trailing edge of the blade shell to form the connecting collar. In such an example, the method may comprise overlaminating the leading edge and trailing edge joints of the connecting fixture to form a smooth outer surface.

In some examples, the repowered wind turbine may further comprise a tension member extending between each blade connecting member and the hub. Each tension member may be configured to apply a tension force pulling the blade connecting member towards the hub. Further, in some examples the repowered wind turbine may comprise one or more linear actuators coupled between the hub and a respective blade connecting member. In some examples such linear actuators may be coupled between the hub and a tension member connected to a blade connecting member.

The linear actuators may be configured to adjust the tension in the respective blade connecting member and/or tension member. For example, each linear actuator preferably has an adjustable length to facilitate adjustment of the tension in the blade connecting member. It will be appreciated that the length of a linear actuator refers to the distance between the points at which other wind turbine components, such as the hub and the blade connecting member or tension member for example, may be connected to the linear actuator. The repowered wind turbine may also comprise an updated control software for example introducing or modifying cyclic and/or individual pitch control as load reduction feature. Inclusion of tension members with linear actuators are particularly advantageous for the wind turbines according to the invention as these features facilitate and improve efficiency of cyclic and individual pitch control for the wind turbines.

In some examples the repowered wind turbine may comprise a support structure extending from the hub in an upwind direction. The tension members, or in some examples the linear actuators, may be connected to the support structure, i.e. may be connected to the hub via the support structure.

### BRIEF DESCRIPTION OF THE DRAWINGS

Examples of the present invention will now be described by way of non-limiting examples only, with reference to the accompanying figures, in which:

FIG. 1 is a schematic perspective view of a repowered wind turbine;

FIG. 2 is a schematic plan view of a repowered wind turbine blade of the repowered wind turbine attached to a hub of the turbine;

FIG. 3a is a schematic plan view of a repowered wind turbine blade comprising a tip extension;

FIG. 3b is a schematic plan view of a repowered wind turbine blade comprising a root extension;

FIG. 4 is a schematic plan view of a repowered wind turbine blade comprising inboard and outboard blade shell sections connected together to form the repowered blade;

FIG. 5 is a schematic cross-sectional view of a connecting fixture attached to a repowered blade; and

FIG. 6 is a schematic cross-sectional view of an example of a connecting fixture that extends around and encloses a portion of the blade shell.

### DETAILED DESCRIPTION

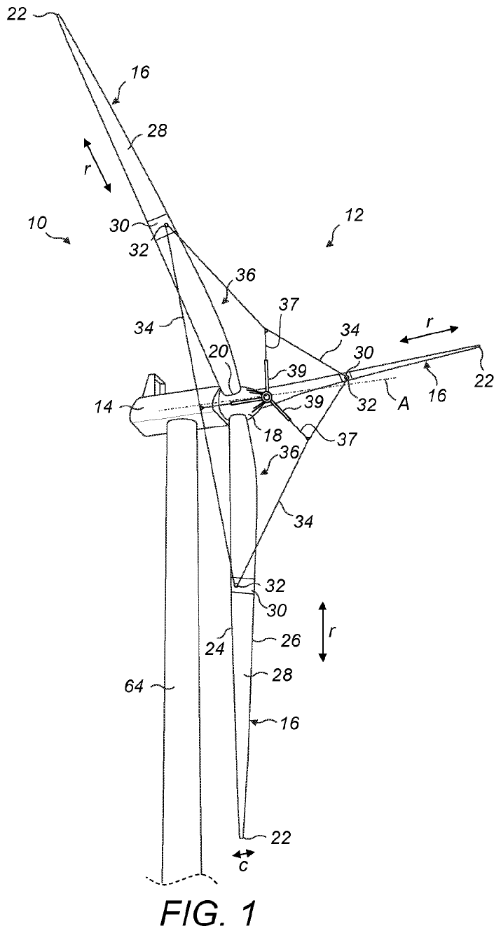

FIG. 1 is a schematic perspective view of a repowered wind turbine 10. As described previously by way of background, a repowered wind turbine 10 is an existing, i.e. used, wind turbine 10 which is upgraded with one or more different components to increase the annual energy production (AEP) of the turbine 10. Accordingly, the repowered wind turbine 10 comprises many of the typical components of a utility-scale wind turbine. For example, the repowered wind turbine 10 comprises a rotor 12 which is rotatably mounted to a nacelle 14. The rotor 12 therefore defines a rotor axis A about which the rotor 12 rotates. The rotor 12 comprises a plurality of repowered wind turbine blades 16 connected to a hub 18. To facilitate rotation of the rotor 12, the hub 18 may be rotatably coupled to the nacelle 14 via a main bearing (not shown).

With reference to the repowered wind turbine blades 16, each repowered blade 16 extends in a radial direction r from a blade root 20 to a blade tip 22. It will be appreciated that the blade root 20 is located at an inboard end of the repowered blade 16 relative to the rotor axis A, and the blade tip 22 is located at an outboard end of the repowered blade 16 relative to the rotor axis A. Further, each repowered blade 16 extends in a chordwise direction c between a leading edge 24 and a trailing edge 26.

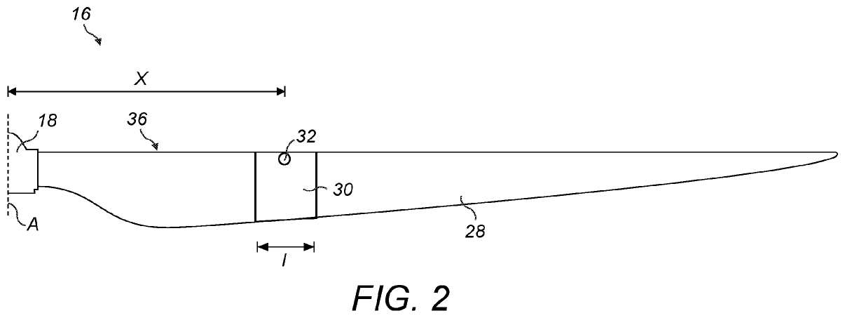

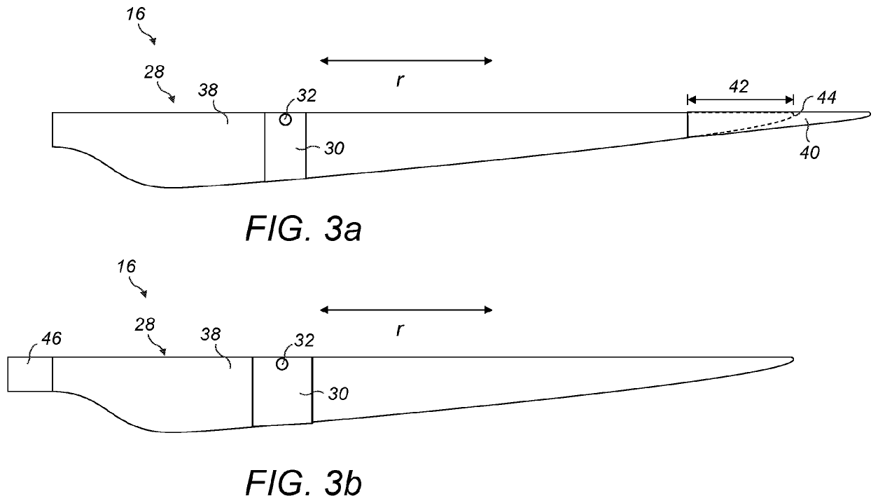

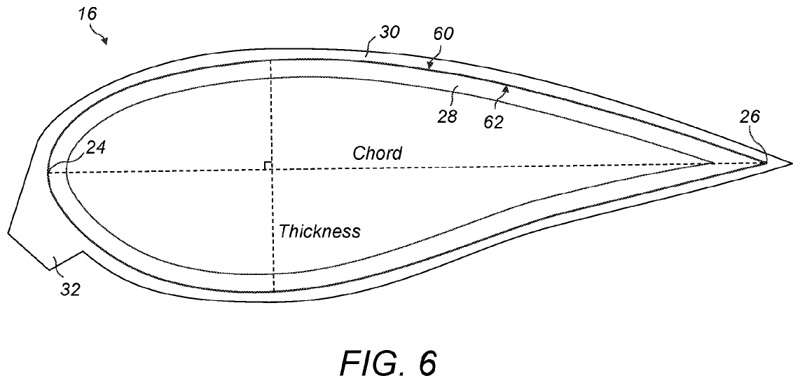

Each repowered blade 16 of the repowered wind turbine 10 comprises a blade shell 28. As shown most clearly in FIG. 6, the blade shell 28 preferably defines an airfoil profile configured to extract energy from wind incident on the repowered blade 16 in use. As will be described in more detail with reference to FIGS. 2 to 4, at least a portion of the blade shell 28 of each repowered blade 16 is formed of at least a portion of a used blade shell of a used wind turbine blade 38 (see FIG. 3). Accordingly, the repowered blades 16 of the repowered wind turbine 10 advantageously re-use blade shell materials from used wind turbine blades 38. This may help to reduce the cost of the repowered blades 16 of the repowered wind turbine 10, and also reduces the amount of raw materials required for producing the repowered blades 16 and hence the carbon foot print of the repowered wind turbine 10.

Referring still to FIG. 1, the repowered wind turbine 10 additionally includes a connecting fixture 30 attached to each repowered blade 16. In the example shown in FIG. 1 the wind turbine 10 comprises three repowered blades 16, and accordingly the turbine 10 comprises three connecting fixtures 30, one attached to each repowered blade 16 of the repowered wind turbine 10. As described in more detail below, each connecting fixture 30 defines a connection point 32 for connecting a blade connecting member 34 to the repowered blade 16.

It follows that the repowered wind turbine 10 further includes one or more blade connecting members 34. Each blade connecting member 34 is connected between corresponding connection points 32 of a pair of repowered wind turbine blades 16. Accordingly, the repowered wind turbine 10 shown by way of example in FIG. 1 comprises three blade connecting members 34. Each repowered blade 16 is therefore connected to at least one other repowered blade 16 by a blade connecting member 34. The connecting fixtures 30 and associated blade connecting members 34 advantageously facilitate repowering an existing wind turbine 10 to increase the rotor diameter whilst still retaining, i.e. not exchanging, many of the components of the existing wind turbine.

For example, the repowering operation may involve exchanging used blades of the existing wind turbine for longer repowered wind turbine blades 16 to extend the diameter of the rotor 12 and thereby capture more energy from the wind. Typically, longer repowered blades 16 experience greater loading in use, particularly in an inboard portion 36 of the repowered blade 16, due to the increased moment loads and weight of the longer repowered blade 16. Accordingly, longer repowered blades 16 are typically configured with larger-diameter root ends 20 to provide the requisite structural support for the repowered blade 16 in use. However, the connecting fixtures 30 and blade connecting members 34 connected between pairs of repowered wind turbine blades 16 advantageously share the blade loads between the connected repowered blades 16 in use. As such, the loads experienced by the inboard portions 36 of repowered blades 16 of the repowered wind turbine 10 are reduced such that the repowered wind turbine 10 may comprise longer repowered blades 16 that do not necessarily need to have larger-diameter root ends 20. Accordingly, longer repowered blades 16 can be fitted to an existing wind turbine during the repowering operation without requiring a new hub 18 and/or interface components to connect the longer repowered blades 16 to the existing hub 18.

In some examples the repowered wind turbine 10 may further include a tension member 37 connected between each blade connecting member 34 and the hub 18. Each tension member 37 may be configured to apply a tension force pulling the blade connecting member 34 towards the hub 18. The tension members 37 advantageously provide an alternative load path for transferring blade loads to the hub 18, bypassing the inboard portion 36 of the repowered blade 16. In such examples, the repowered turbine 10 may additionally include a tension adjustment system 39 coupled between the tension member 37 and the hub 18 to facilitate adjustment of the tension in the tension member 37 and associated blade connecting member 34. In some examples the tension adjustment system 39 may comprise a linear actuator coupled between each respective tension member 37 and the hub 18. For example, each linear actuator preferably has an adjustable length to facilitate adjustment of the tension in the tension member 37 and associated blade connecting member 34.

An example of a repowered wind turbine blade 16 of the repowered wind turbine 10 is shown in FIG. 2. For ease of reference, a wind turbine blade 16 of the repowered wind turbine 10 may be referred to herein as a repowered wind turbine blade 16, or repowered blade 16. As previously described, the repowered blade 16 is attached to the hub 18 of the repowered wind turbine 10. It will be appreciated that a single repowered blade 16 is shown in FIG. 2 for clarity, but in reality, the rotor 12 comprises a plurality of repowered blades 16 connected to the hub 18.

As described previously, the repowered wind turbine 10 comprises a connecting fixture 30 attached to each repowered blade 16 to provide a connection point 32 for connecting one or more blade connecting members 34 to the repowered blade 16. The connecting fixture 30 may be part of the used blade or be a retrofitted connecting fixture 30. It is highly preferred that the connecting fixture 30 is a retrofitted connecting fixture 30 as this enables the repowered blade 16 to be manufactured from used blades 38 that were not originally (during the first use of the blade) used as a cable-stayed blades and hence allows for more diverse reuse and much greater increase in length of the repowered blade as compared to the used blade. In some examples, the connecting fixture 30 may be retrofitted to an outer surface of the blade shell 28 of the repowered blade 16. For example, the connecting fixture 30 may be bonded to the repowered blade 16 using adhesive. A bonded connection provides a large surface area over which to transfer loads between the blade shell 28 and connecting fixture 30 in use. In some examples (not shown) each connecting fixture 30 may be attached to each respective repowered blade 16 by a plurality of fixing members that extend into the blade shell 28. This may provide additional security for attaching the connecting fixture 30 to the repowered blade 16 and may provide additional load paths for transferring loads between the blade shell 28 and the connecting fixture 30.

As shown in FIG. 2, the connecting fixture 30 is preferably attached to the repowered blade 16 such that the connection point 32 is located at a radial distance X of between 0.25R to 0.55R from the rotor axis A. R represents half of the rotor diameter and may therefore be referred to as the rotor radius. Providing the connection point 32 at a radial distance X of between 0.25R to 0.55R from the rotor axis A advantageously diverts a significant proportion of blade loads to the or each blade connecting member 34 and away from the inboard portion 36 of the repowered blade 16. Further a connection point 32 located in this range provides an advantageous compromise between load reduction in the inboard portion 36 and increased noise and aerodynamic drag resulting from the connecting fixture 30 and associated connecting members 34.

Referring still to FIG. 2, and with brief reference additionally to the cross-sectional view shown in FIG. 6, each repowered blade 16 comprises a chord length which is the length between the leading edge 24 and the trailing edge 26 at any given radial location. It will be appreciated that the chord length varies along the radial length of the repowered blade 16 due to the varying aerodynamic profile of the repowered blade 16.

In preferred examples, such as those shown in the accompanying figures, each connecting fixture 30 is preferably configured with a length/of between 0.5C and 1.5C, where C is the chord length at the connection point. Accordingly, each connecting fixture 30 preferably extends over a radial extent of between 0.5C and 1.5C. With this configuration, the connecting fixture 30 has an advantageous surface area to attach to the blade shell 28. Additionally, in some examples this may allow the formation of an advantageous tapered outer surface of the connecting fixture 30 to provide a smooth aerodynamic transition from the blade shell 28 to the connecting fixture 30.

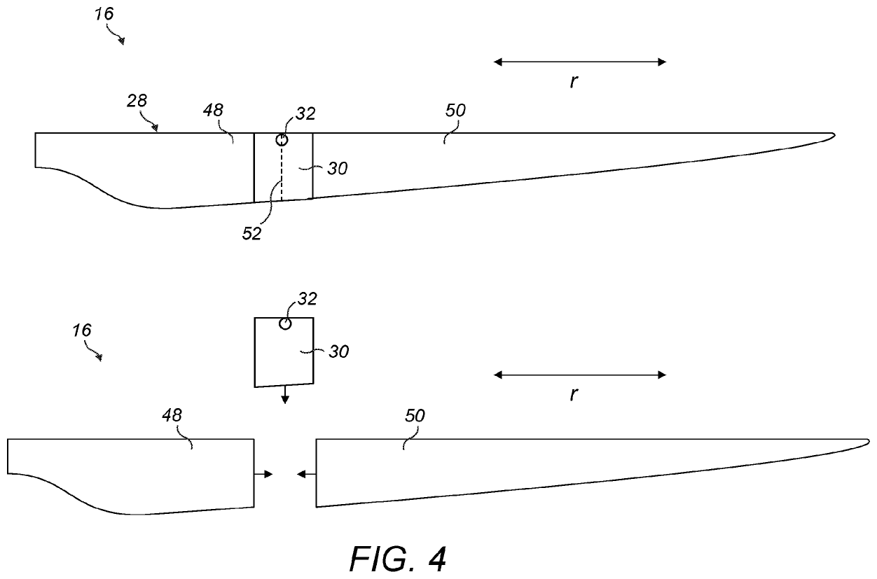

As mentioned previously, at least a portion of the blade shell 28 of each repowered blade 16 is formed of at least a portion of a used blade shell of a used wind turbine blade. FIGS. 3a to 4 show examples of repowered blades 16 which each comprise a blade shell 28 formed of at least a portion of a used blade shell. It will be appreciated that the general description of the repowered blades 16 provided previously with reference to FIGS. 1 and 2 is applicable to the examples of repowered blades 16 in each of FIGS. 3a to 4.

Further, it will be appreciated that features of the repowered blades 16 described with reference to any of FIGS. 3a to 4 may be applicable to, and readily combined with, the features of any other example described herein.

Referring now to FIGS. 3a and 3b, the blades 16 of the repowered wind turbine 10, i.e. the repowered blades 16, may comprise a used wind turbine blade 38. Accordingly, part of the blade shell 28 of each repowered blade 16 may be formed of a used wind turbine blade 38. For example, the used wind turbine blade 38 may be the original wind turbine blade of the existing turbine. In other examples, the used wind turbine blade 38 may have been used on a different wind turbine.

As shown in FIG. 3a, the repowered wind turbine blade 16 may comprise a retrofitted tip extension 40 attached to the used wind turbine blade 38. In some examples, the tip extension 40 may comprise a sleeve portion 42 configured to fit over a tip end 44 of the used wind turbine blade 38 to facilitate fast and simple attachment of the tip extension 40 to the used blade 38 when making the repowered wind turbine blade 16. The tip extension 40 may be attached to the used blade 38 with adhesive (not shown). Each tip extension 40 preferably defines the tip end 22 of each respective blade 16 of the repowered wind turbine 10. Attachment of the tip extension 40 may provide a repowered blade 16 that is at least 4 m longer than the used wind turbine blade 38.

Referring now to FIG. 3b, in some examples the repowered blades 16 may comprise a retrofitted root extension 46 attached to the used wind turbine blade 38. Accordingly, the used wind turbine blade 38 may be connected to the rotor hub 18 via the root extension 46 in such an example. It will be appreciated that the root extension 46 increases the overall length of the repowered wind turbine blade 16 to provide a repowered blade that is longer than the used wind turbine blade 38. Whilst not shown in the accompanying figures, in some examples the repowered blades 16 may include both a root extension 46 and a tip extension 40 attached to the used wind turbine blade 38.

As described previously, the provision of connecting fixtures 30 and blade connecting members 34 reduces the loading of the inboard portion 36 of each repowered blade 16.

As such, the connecting fixtures 30 and blade connecting members 34 of the repowered wind turbine 10 facilitate the use of used wind turbine blades 38 as part of larger repowered wind turbine blades 16, because the loading experienced by each used repowered wind turbine blade 38 may not exceed the loading for which the used blade 38 was originally designed, despite the repowered blades 16 being longer than the used blades 38. For the same reason, in some preferred examples the root-end diameter of the repowered blade 16 may be substantially the same as a root-end diameter of the used blade 38, because an increase in root-end diameter is not required for structural support despite the additional blade length.

Another example of a blade 16 of the repowered turbine 10 is shown in both plan view and an exploded view in FIG. 4. As described with reference to the examples of the preceding figures, the repowered blade 16 comprises a blade shell 28 formed of at least a portion of a used blade shell of a used wind turbine blade 38. In some examples, such as that shown in FIG. 4, the blade shell 28 of a blade 16 of the repowered wind turbine 10 may comprise an inboard shell section 48 and an outboard shell section 50. The inboard and outboard sections 48, 50 may be connected together to form the shell 28 of the repowered blade 16. As shown in FIG. 4, in some preferred examples the inboard shell section 48 of a blade 16 of the repowered wind turbine 10 may comprise at least 25% of the total length of the repowered blade 10.

The inboard section 48 of the blade shell 28 may be formed of at least part of an inboard portion of a used blade shell. Additionally or alternatively, the outboard section 50 of the shell 28 of the repowered blade 16 may be formed of at least part of an outboard portion of a used blade shell. Accordingly, a used blade shell may be repurposed and modified to form the inboard or outboard shell section 48, 50 of the repowered blade 16. Such modification may involve cutting a used blade at a given radial location to form an inboard section 48 or an outboard section 50 of a specified length for the blade shell 28 of the repowered blade 16. Accordingly, a significant portion of a used blade may be reused to form the respective repowered blades 16 of the repowered wind turbine 10. Such reuse is both environmentally and financially advantageous.

In examples where the repowered wind turbine blades 16 comprise inboard and outboard sections 48, 50 as described above, the respective connecting fixture 30 may be attached to both the inboard section 48 and the outboard section 50 of the blade shell 28. As such, the connecting fixture 30 may extend across a joint 52 between the inboard and outboard shell sections 48, 50. In some examples the connecting fixture 30 may provide an aerodynamic benefit by covering the joint 52 between the blade sections 48, 50, thereby reducing drag. Further, in some examples, the inboard section 48 of each blade shell 28 may be connected to the respective outboard section 50 by the connecting fixture 30. As such, the connecting fixture 30 may serve a dual purpose of providing a connection point 32 for connecting a blade connecting member 34, as well as serving to connect the inboard and outboard shell sections 48, 50.

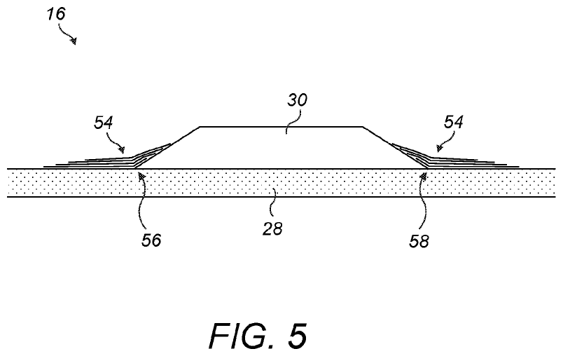

Reference is now made to FIG. 5, which shows a cross-sectional view of the connecting fixture 30 attached to the blade shell 28 of a repowered wind turbine blade 16. It will be appreciated that the repowered blade 16 shown in FIG. 5 may be a repowered blade 16 as described with reference to any of the examples of any of the preceding figures. The blades 16 of the repowered wind turbine 10 may additionally include one or more layers of reinforcing material 54. The reinforcing material 54 may be laminated over an inboard edge 56 and/or over an outboard edge 58 of the connecting fixture 30 when the fixture 30 is arranged with the repowered blade 16. This overlamination may help to provide a stronger connection between the connecting fixture 30 and the blade shell 28. Further, in some examples the overlaminated layers of reinforcing material 54 may advantageously smooth the transition between the blade shell 28 and connecting fixture 30, thereby reducing drag.

FIG. 6 shows a cross sectional view of an example of a connecting fixture 30 attached to the blade shell 28. In preferred examples, such as those shown in the accompanying figures, each connecting fixture 30 comprises an inner profile 60 shaped to substantially match an outer profile 62 of the portion of the blade shell 28 to which the connecting fixture 30 is attached. This helps to distribute loads over a large surface area to avoid load concentrations when transferring loads between the blade shell 28 and connecting fixture 30 in use. Additionally, substantially matching the inner profile 60 of the connecting fixture 30 to the blade shell profile 62 may simplify accurate arrangement of the connecting fixture 30 on the blade shell 28.

As shown in FIG. 6, in some examples the connecting fixture 30 may extend around a leading edge 24 of the repowered blade 16. Such a configuration facilitates the provision of one or more connection points 32 near to the leading edge 24 of the repowered blade 16, i.e. within 0.5C from the leading edge 24 (i.e. in front of or behind the leading edge 24). Locating a connection point 32 in this region is particularly advantageous for reducing pitch loads in use, and also for minimising the risk of a blade connecting member 34 clashing with the blade shell 28 when pitching the repowered blades 16 in use.

Referring still to FIG. 6, the connecting fixture 30 may, in some examples, extend around and enclose, i.e. surround, the portion of the blade shell 28 to which the fixture 30 is attached. As such, the connecting fixture 30 may be configured as a collar around the blade shell 28. Such a configuration may provide particularly secure attachment of the connecting fixture 30 to the blade shell 28, and may further provide an advantageous surface area for transferring loads between the blade shell 28 and connecting fixture 30 in use. A collar configuration may be particularly advantageous in examples where the connecting fixture 30 spans joint 52 between inboard and outboard shell sections 48, 50 of a repowered wind turbine blade shell 28, because the additional surface area afforded by this configuration may add strength to the joint 52.

It will be appreciated that the description provided above with reference to the accompanying figures is provided by way of example only. Further, it should be understood that any feature described with reference to a particular example and/or figure may be equally applicable to any other example described herein. Additionally, it will be appreciated that some examples of the present invention are not shown in the figures.

For example, in some examples, the repowered wind turbine 10 may comprise one or more shim angle adjustment members (not shown) arranged between the blade root 20 and the hub 18. Accordingly, each repowered blade 16 may be connected to the hub 18 via one or more shim angle adjustment members. The shim angle adjustment members are preferably configured to set the inclination of the repowered blade 16 relative to a pitch axis of the repowered blade 16 in a plane perpendicular to the rotor plane (out of plane shim angle) and/or relative to the pitch axis in a plane parallel to the rotor plane (in plane shim angle). As an example, the repowered wind turbine 10 may include such shim angle adjustment members to increase the out of plane shim angle to reduce the risk of longer repowered blades 16 hit a tower 64 of the repowered turbine in high wind conditions.

Reference to the inclination of the repowered blade 16 should be understood to refer to an angle defined between the specified reference and a theoretical centre line of the repowered blade 16. As used herein, the theoretical centre line of the repowered blade 16 connects a centre point of the blade root 20 and a blade centre at the radial location of the connection point 32 (where the blade centre is defined as the intersection of the chord between the leading and trailing edges 24, 26 and a thickness line orthogonal to the chord at the maximum thickness, at the given radial location).

In some examples, the repowered wind turbine 10 may include a hub extender (not shown). Accordingly each blade 16 of the repowered wind turbine 10 may be connected to the hub 18 via the hub extender. A hub extender may be used in combination with any of the examples described herein to increase the diameter of the rotor 12 during the repowering operation to facilitate the capture of more energy from the incident wind. A hub extender may also be used to adjust in plane shim angle and/or out of plane shim angle and/or adapt the blade diameter and/or bolt arrangement of the blade root to the hub.

In the examples shown schematically in each of FIGS. 3a and 3b, the repowered wind turbine blade 16 comprises either a tip extension 40 or a root extension 46. It will be appreciated that in some examples, the blades 16 of the repowered wind turbine 10 may comprise both a tip extension 40 and a root extension 46. Further, in some examples, repowered blades comprising inboard and outboard shell sections 48, 50 such as those described with reference to FIG. 4 may also comprise a tip extension 40 and/or a root extension 46.

Further, in the example of a repowered blade 16 comprising shell sections 48, 50 shown in FIG. 4, the inboard section 48 defines the blade root 20, and the outboard section 50 defines the blade tip 22. However, it will be appreciated that the inboard and outboard sections 48, 50 are defined relative to one another and the rotor axis A. That means that the inboard section 48 is inboard of the outboard section 50 relative to the rotor axis A, and accordingly the outboard section 50 is outboard of the inboard section 48, relative to the rotor axis A. As such, in some examples (not shown) the inboard section 48 may not define the blade root 20 of the repowered blade 16. Additionally or alternatively, in some examples the outboard section 50 may not define the blade tip 22 of the repowered blade 16. Accordingly, the inboard and/or outboard blade shell section 48, 50 may be an intermediate shell section defining at least part of a central portion of the shell 28 between the blade root 20 and blade tip 22 of the repowered blade 16.

Finally, in the examples described with reference to the accompanying figures the repowered wind turbine 10 comprises three repowered wind turbine blades 16. It will be appreciated that the examples described herein are not limiting. Accordingly, it will be appreciated that in some examples, the repowered wind turbine 10 may comprise two repowered blades 16 and a blade connecting member 34 connected between connecting points 32 defined by connecting fixtures 30 attached to each repowered blade 16, or a higher number of repowered blades, such as four blades 16 with connecting members 34 between adjacent blades. However, in preferred examples, the repowered wind turbine 10 preferably comprises three repowered blades 16 with each repowered blade 16 being connected to the other two repowered blades 16 via respective blade connecting members 34, as described above.

It will be appreciated that the description provided above serves to demonstrate a plurality of possible examples of the present invention. Features described in relation to any of the examples above may be readily combined with any other features described with reference to different examples without departing from the scope of the invention as defined in the appended claims.

1. A repowered wind turbine comprising:
a rotor rotatably mounted to a nacelle, the rotor defining a rotor axis and the rotor comprising a plurality of repowered wind turbine blades connected to a hub, each repowered blade extending in a radial direction from a blade root to a blade tip and in a chordwise direction between a leading edge and a trailing edge, and each repowered blade comprising a blade shell, wherein at least a portion of the blade shell is formed of at least a portion of a used blade shell of a used wind turbine blade;
a connecting fixture attached to each repowered blade, each connecting fixture defining a connection point for connecting a blade connecting member to the repowered blade; and
one or more blade connecting members, each blade connecting member being connected between corresponding connection points of a pair of repowered wind turbine blades such that each repowered blade is connected to at least one other repowered blade by a blade connecting member.

2. The repowered wind turbine of claim 1, wherein each repowered blade comprises a used wind turbine blade and a retrofitted tip extension attached to the used wind turbine blade.

3. The repowered wind turbine of claim 1, wherein each repowered blade comprises a used wind turbine blade and a retrofitted root extension attached to the used wind turbine blade.

4. The repowered wind turbine of claim 1, wherein at least part of an inboard section of the blade shell of each repowered blade is formed of at least part of an inboard portion of a used blade shell, and/or wherein at least part of an outboard section of the blade shell of each repowered blade is formed of at least part of an outboard portion of a used blade shell.

5. The repowered wind turbine of claim 4, wherein each connecting fixture is attached to both the inboard section and the outboard section of each respective blade shell.

6. The repowered wind turbine of claim 5, wherein the inboard section of each blade shell is connected to the outboard section of the respective blade shell by the connecting fixture.

7. The repowered wind turbine of claim 4, wherein the inboard section of each blade comprises at least 25%, preferably at least 40%, more preferably at least 55% of the total length of the repowered blade.

8. The repowered wind turbine of claim 1, wherein the connecting fixture is a retrofitted connecting fixture.

9. The repowered wind turbine of claim 1, wherein each connecting fixture is retrofitted to an outer surface of the blade shell of each respective repowered blade.

10. The repowered wind turbine of claim 1, wherein each repowered wind turbine blade is connected to the hub via a hub extender.

11. The repowered wind turbine of claim 1, wherein each connecting fixture extends over a radial extent of between 0.5C and 1.5C, where C represents the chord length between the leading edge and the trailing edge of the repowered blade at the connection point.

12. The repowered wind turbine of claim 1, wherein each connecting fixture is attached to a respective repowered blade such that the connection point is located at a radial distance of between 0.25R to 0.55R from the rotor axis, where R represents half of the rotor diameter.

13. The repowered wind turbine of claim 1, wherein each connecting fixture is bonded to each respective repowered blade using adhesive.

14. The repowered wind turbine of claim 1, wherein each connecting fixture is attached to each respective repowered blade by a plurality of fixing members that extend into the blade shell.

15. The repowered wind turbine of claim 1, wherein each repowered wind turbine blade comprises one or more layers of reinforcing material laminated over an inboard edge of the connecting fixture attached to the repowered blade, and/or one or more layers of reinforcing material laminated over an outboard edge of the connecting fixture attached to the repowered blade.

16. The repowered wind turbine of claim 1, wherein each repowered blade is connected to the hub via one or more shim angle adjustment members.

17. The repowered wind turbine of claim 1, wherein each connecting fixture comprises an inner profile shaped to substantially match an outer profile of the blade shell to which the connecting fixture is attached.

18. The repowered wind turbine of claim 1, wherein each connecting fixture extends around a leading edge of the repowered blade to which the fixture is attached.

19. The repowered wind turbine of claim 1, wherein each connecting fixture comprises a connecting collar that extends around and encloses a portion of the blade shell where the connecting fixture is attached.
